(19) United States
(12) Patent Application Publication
(10) Pub. No.: US 2024/0072386 A1
(43) Pub. Date: Feb. 29, 2024

(54) Cell and Secondary Battery

(71) Applicant: JIANGSU ZENERGY BATTERY TECHNOLOGIES CO., LTD., Jiangsu (CN)

(72) Inventors: Tao REN, Jiangsu (CN); Hongyong LIU, Jiangsu (CN); Wenhui DENG, Jiangsu (CN); Zhexun YU, Jiangsu (CN)

(21) Appl. No.: 18/237,329

(22) Filed: Aug. 23, 2023

(30) Foreign Application Priority Data
Aug. 24, 2022 (CN) 202222232840.3

(51) Int. Cl. H01M 50/531; H01M 10/04

(52) U.S. Cl. CPC H01M 50/531; H01M 10/04

(57) ABSTRACT

Disclosed are a cell and a secondary battery. The cell includes a cell body; a length of the cell body is L, and a thickness of the cell body is H; and the L and the H satisfy the following relational expression: L/H>7. According to the cell and the secondary battery provided in the disclosure, by reasonably designing a relationship between the length L and the thickness H of the cell body, that is, a ratio between the length L and the thickness H of the cell body is defined within a specific relational expression of L/H>7, the heat dissipation performance of the cell is improved, and the heat inside the cell is discharged to the outside timely, such that the service life and safety performance of the secondary battery are improved, thereby having a higher potential for market promotion.

### CROSS-REFERENCE TO RELATED APPLICATION

The disclosure claims priority to and the benefit of Chinese Patent Application No. 202222232840.3, filed to the China National Intellectual Property Administration (CHIPA) on 24 Aug. 2022, which is hereby incorporated by reference in its entirety.

### TECHNICAL FIELD

The disclosure relates to the technical field of batteries, and in particular to a cell and a secondary battery.

### BACKGROUND

A lithium-ion battery is a rechargeable battery, or a secondary battery, and generally consists of a battery, electrolyte and a housing; and a cell therein further includes a positive electrode plate, a negative electrode plate, and a separator. Because the lithium-ion battery has prominent characteristics such as light weight, high energy density, no pollution, no memory effect, and long service life, the lithium-ion battery is widely applied to fields of mobile phones, computers, home appliances, and electric power tools.

At present, in order to shorten charging time and improve charging experience of a user, the current lithium-ion battery generally has the capability of quick charging. However, when the lithium-ion battery is rapidly charged or discharged at high rate, due to large charging and discharging current, heat generated by the battery is increased, resulting in a relatively high temperature rise. If the heat is not discharged to the outside timely, the service life and safety performance of the battery may be severely affected.

Therefore, how to improve heat dissipation of the battery has become a pressing technical problem for those skilled in the art to solve.

The above information is given as background information only to assist in understanding the disclosure and does not determine or acknowledge whether any of the foregoing may be used as the related art relative to the disclosure.

### SUMMARY

The disclosure provides a cell and a secondary battery, to solve the disadvantages of the related art.

In order to achieve the above objective, the disclosure provides the following technical solutions.

Some embodiments of the disclosure provide a cell, which includes a cell body, and a length of the cell body is L, and a thickness of the cell body is H;
the length L and the thickness H satisfy the following relational expression: L/H>7.

In some embodiments, the cell further includes a tab;
the tab is connected to the cell body and is led out from the cell body;
a width of the tab is M.

The length L and the width M satisfy the following relational expression: L>5M.

In some embodiments, in the cell, there are a plurality of tabs, and the plurality of tabs include a positive tab and a negative tab 22;
the positive tabs and the negative tabs are arranged at intervals along a length direction of the cell body.

In some embodiments, in the cell, there are a plurality of tabs, and the plurality of tabs include a plurality of positive tabs and a plurality of negative tabs;
the plurality of positive tabs and the plurality of negative tabs are arranged at intervals along a length direction of the cell body;
the plurality of positive tabs are arranged at intervals along the length direction of the cell body;
the plurality of negative tabs are arranged at intervals along the length direction of the cell body.

Some other embodiments of the disclosure provide a secondary battery, which includes a cell and a housing accommodating the cell, and the cell is the cell as described above.

Compared with the related art, the disclosure has the following beneficial effects.

According to the cell and the secondary battery provided in the disclosure, by reasonably designing a relationship between the length L and the thickness H of the cell body, that is, a ratio between the length L and the thickness H of the cell body is defined within the specific relational expression of L/H>7, the heat dissipation performance of the cell is improved, and the heat inside the cell is discharged to the outside timely, such that the service life and safety performance of the secondary battery are improved, thereby having a high potential in market promotion.

### BRIEF DESCRIPTION OF THE DRAWINGS

In order to illustrate the technical solutions in the embodiments of the disclosure or technical solutions in the related art more clearly, the drawings used in the technical description of the embodiments will be briefly described below. It is apparent that the drawings in the following descriptions are merely some embodiments of the disclosure. Other drawings can be obtained from those skilled in the art according to these drawings without any creative work.

FIG. 1 is a three-dimensional structural schematic diagram of a cell according to Embodiment 1 of the disclosure.

FIG. 2 is a front view of a cell according to Embodiment 1 of the disclosure.

FIG. 3 is another front view of a cell according to Embodiment 1 of the disclosure.

### REFERENCE NUMERALS

10—cell body; 20—tab;
11—positive electrode plate; 12—separator; 13—negative electrode plate;
21—positive tab; 22—negative tab.

### DETAILED DESCRIPTION OF THE EMBODIMENTS

In order to make the purpose, features and advantages of the disclosure more obvious and easier to understand, the technical solutions in the embodiments of the disclosure will be clearly and completely described below in combination with the drawings in the embodiments of the disclosure. It is apparent that the described embodiments are only part of the embodiments of the disclosure, not all the embodiments. Based on the embodiments in the disclosure, all other embodiments obtained by those of ordinary skill in the art without creative work shall fall within the protection scope of the disclosure.

In the description of the disclosure, it is to be understood that, when a component is considered to be “connected” to another component, it may be directly connected to the other component or an intermediate component may exist at the same time. When a component is considered to be “arranged” on another component, it may be directly arranged on the other component or an intermediate component may exist at the same time.

In addition, direction or position relationships indicated by terms such as “long”, “short”, “inside”, and “outside” and the like are direction or position relationships based on the accompanying drawings, and are merely intended to facilitate the descriptions of the disclosure, rather than indicating or implying that a referred apparatus or element must have a particular direction or be constructed and operated in a particular direction. Therefore, these terms should not be interpreted as limiting the disclosure.

The technical solutions of the disclosure are further described below with reference to the drawings and by means of specific embodiments.

### Embodiment 1

In views of defects in a related cell heat dissipation technology, based on years of practical experience and professional knowledge in the design and manufacture of such products, and with the application of theories, the applicant actively researches and innovates in the hope of creating technologies that is able to solve the defects in the related art and make the cell heat dissipation technology more practical. After continuous research and design, and after repeated trial samples and improvements, the disclosure with practical values is finally created.

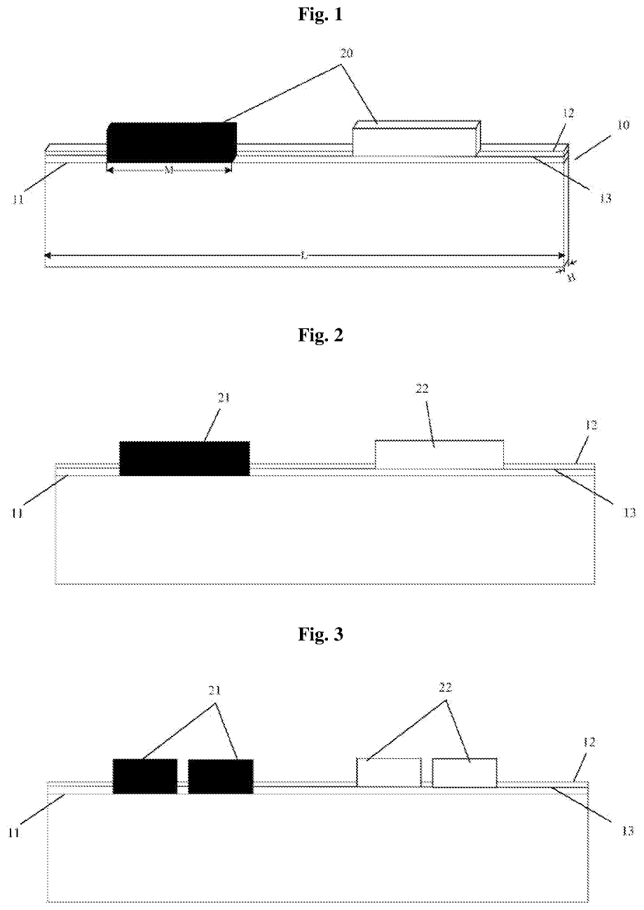

Referring to FIG. 1, an embodiment of the disclosure provides a cell, which includes a cell body 10. A length of the cell body 10 is L, and a thickness of the cell body 10 is H.

The length L and the thickness H satisfy the following relational expression: L/H>7.

It is to be noted that, the cell body 10 is formed by stacking or winding or stacking and winding a positive electrode plate 11, a separator 12, and a negative electrode plate 13 in sequence, as shown in FIG. 1.

With regard to high capacity cells on the market (initial capacity >100 Ah), a ratio of a designed length of the cells to a thickness is generally between 2 and 5; and the thickness is relatively large, which is adverse to a timely outward transfer of heat inside the high capacity cells, and is easily to reduce a service life and safety performance of a secondary battery when discharging at high rate. In the embodiment, by reasonably designing the relationship between the length L and the thickness H of the cell body 10, that is, the ratio between the length L and the thickness H of the cell body 10 is defined within the specific relational expression of L/H>7, a reduction of the thickness of the cell is more conductive to heat dissipation at a constant capacity.

Further referring to FIG. 1, in the embodiment, the cell further includes a tab 20, the tab 20 is connected to the cell body 10 and led out from the cell body 10.

A width of the tab 20 is M, and the length L and the width M satisfy the following relational expression: L>5M.

It is to be noted that, it is well known that the battery has a positive electrode and a negative electrode. The tab 20 is a metallic conductor that leads positive and negative electrodes from the cell body 10. Generally, the tab is a contact point when the cell is charged and discharged. In order to further improve the heat dissipation capability of the cell, in the embodiment, after the relationship between the length L and the thickness H of the cell body 10 is reasonably designed, and the relationship between the length L of the cell body 10 and the width M of the tab 20 is then reasonably designed, that is, the ratio of the length L of the cell body 10 to the width M of the tab 20 is defined within the specific relational expression of L>5M, such that the purpose of improving the heat dissipation capability of the cell is achieved.

In the embodiment, the tab 20 includes a positive tab 21 and a negative tab 22. The positive tab 21 is formed on a side of the positive electrode plate 11 by means of die cutting; and the negative tab 22 is formed on a side of the negative electrode plate 13 by means of die cutting.

In an embodiment, there are only one positive tab 21 and one negative tab 22. That is to say, the tab 20 includes one positive tab 21 and one negative tab 22.

Referring to FIG. 2, the positive tabs 21 and the negative tabs 22 are arranged at intervals along a length direction of the cell body 10.

In another embodiment, there are a plurality of positive tabs 21 and a plurality of negative tabs 22. That is to say, the tab 20 includes the plurality of positive tabs 21 and the plurality of negative tabs 22.

Specifically, in the embodiment, two positive tabs 21 and two negative tabs 22 are configured as examples for description. Referring to FIG. 3, the plurality of positive tabs 21 and the plurality of negative tabs 22 are arranged at intervals along the length direction of the cell body 10.

The plurality of positive tabs 21 are arranged at intervals along the length direction of the cell body 10; and the plurality of negative tabs 22 are arranged at intervals along the length direction of the cell body 10.

Since the number of the tab 20 is directly proportional to the heat dissipation capability of the cell body 10, in the embodiment, the plurality of positive tabs 21 are arranged at a plurality of positions on a side of the cell body 10, and at the same time, the plurality of negative tabs 22 are arranged at a plurality of positions. In addition, the plurality of positive tabs 21 and the plurality of negative tabs 22 are ultrasonically welded to a plurality of current collector plates respectively, such that the resistance and heat generation at an ultrasonic welding position are reduced by effectively increasing a welding area between the tab 20 and each of the plurality of current collector plates (a current passing area being increased), thereby avoiding cracking of the tab and shrinkage of the separator 12 at the root of the tab, and improving the safety performance of the secondary battery.

In order to verify a feasibility of the solution provided in the embodiment, a temperature rise test experiment after rate discharge of cell and a cycle life test experiment are respectively performed.

(1) Experiment 1: Temperature Rise Test Experiment after Rate Discharge of Cell:

Temperature sensing lines are placed at positions of the plurality of current collector plates inside the cell at 117 Ah; 0.33 C, 1 C, 3 C, and 5 C rate discharge are respectively performed, and then the temperature rise of the cell at each position is monitored; and the tab 20 and the current collector plate have the same welding area.

Shapes of the plurality of current collector plate: the plurality of current collector plates with the same length, width, and thickness.

Experimental group: the plurality of current collector plates are first ultrasonically welded to the tab 20 (tabs at both positive and negative electrode positions being a single tab, and the welding area being 6*30 mm²), and are then in laser welding with an electrode post.

Control group: the plurality of current collector plates are first ultrasonically welded to the tab 20 (tabs at both positive and negative electrode positions being double tabs, and the welding area being 6*30 mm²), and are then in laser welding with the electrode post.

The temperature rises of the plurality of current collector plates inside the cell, the temperature rise of the external electrode post, and the temperature rise of a large-area of the external cell are monitored.

A test flow of the rate discharge of cell includes the following steps.
At S1, standing for 5 minutes.
At S2, 1.0 C CC to 4.4V and CV to I≤0.05 C
At S3, standing for 60 minutes.
At S4, 1.0 C DC to 2.8V (recording a capacity being C0)
At S5, standing is performed for 60 minutes.
At S6, 1.0 C CC to 4.4V and CV to I≤0.05 C0
At S7, standing for 60 minutes.
At S8, 100 DC to 2.8V (discharge rates being 0.33 C0)
At S9, standing for 60 minutes.
At S10, S6-S9 are repeated, and the discharge rates are respectively 0.33 C0, 1C0, 3C0, and 5 C0.

| | | 5C0 external | 5C0 internal |
|---|---|---|---|
| | 5C0 external | positive | positive current |
| | large-area | electrode post | collector plate |
| | temperature/ | temperature/ | temperature/ |
| Experiment 1 | ° C. | ° C. | ° C. |
| One position for each | 59.7 | 70.3 | 75.3 |
| of the positive and | | | |
| negative tabs | | | |
| (experimental group) | | | |
| Two positions for each | 45.2 | 47.3 | 49.7 |
| of the positive and | | | |
| negative tabs (control | | | |
| group) | | | |
| Comparison | −14.5 | −23.0 | −25.6 |

It is seen that, arranging the plurality of positive tabs 21 at the plurality of positions on a side of the cell body 10, and at the same time, arranging the plurality of negative tabs 22 at the plurality of positions is able to effectively reduce a temperature rise after the rate discharge of cell.

(1) Experiment 2: Cycle Life Test Experiment:

Shapes of the plurality of current collector plates: the plurality of current collector plates with the same length, width, and thickness.

Experimental group: the plurality of current collector plates are first ultrasonically welded to the tab 20 (tabs at both positive and negative electrode positions being the single tab, and the welding area being 6*30 mm²), and are then in laser welding with the electrode post.

Control group: the plurality of current collector plates are first ultrasonically welded to the tab 20 (tabs at both positive and negative electrode positions being double tabs, and the solder print area being 6*30 mm²), and are then in laser welding with the electrode post, and then a thermally conductive insulating adhesive is coated on the plurality of current collector plates.

A capacity attenuation rate of cell cycling at 25° C. is monitored, and the capacity attenuation rate being P=Cn/C0, wherein Cn is the capacity discharged after the cell finishes the nth cycle and full charge, and C0 is the capacity discharged after the cell finishes the first cycle and full charge.

A test flow of the cycle life includes the following steps.
At S1, capacity calibration is performed.
At S1.1, standing for 5 min.
At S1.2, 1.0 C DC 2.8V.
At S1.3, standing for 30 min.
At S1.4, 1.0 C CC 4.35V and CV to I≤0.05 C
At S1.5, standing for 60 min.
At S1.6, 1.0 C DC to 2.8V (recording the capacity of this step to be an initial capacity C0).
At S1.7, standing for 60 min.
At S2, voltage calibration is performed.
At S2.1, standing for 5 min.
At S2.2, 1C DC to 2.8V.
At S2.3, standing for 30 min.
At S2.4, 4.700 CC 2.55 min (recording a terminal voltage V1).
At S2.5, 4.200 CC 2.86 min (recording a terminal voltage V2).
At S2.6, 3.800 CC 3.16 min (recording a terminal voltage V3).
At S2.7, 3.500 CC 3.43 min (recording a terminal voltage V4).
At S2.8, 0.800 CC 7.5 min (recording a terminal voltage V5).
At S2.9, standing for 5 min.
At S3, a cycle test flow of step charge at 25° C. includes the following steps.
At S3.1, standing for 5 min.
At S3.2, 10 DC to 2.8V.
At S3.3, standing for 90 min.
At S3.4, 4.7 Cn CC to V1.
At S3.5, 4.2 Cn CC to V2.
At S3.6, 3.8 Cn CC to V3.
At S3.7, 3.5 Cn CC to V4.
At S3.8, 0.8 Cn CC to V5.
At S3.9, 0.33 Cn CC to 4.25V.
At S3.10, 0.2 Cn CC to 4.3V.
At S3.11, standing for 90 min.
At S3.12, 10 DC to 2.8V.
   At S3.13, S3.3-3.12 are repeated and stopped until the capacity attenuates to 80% of the initial.

| | 500 Cycle | 1000 Cycle |
|---|---|---|
| | Capacity | Capacity |
| | retention | retention |
| Experiment 2 | rate/% | rate/% |
| One position for each of the positive | 94.6 | 87.6 |
| and negative tabs (experimental group) | | |
| Two positions for each of the positive | 96.1 | 89.6 |
| and negative tabs (control group) | | |
| Comparison | +1.5 | +2 |

It is seen that, arranging the plurality of positive tabs 21 at the plurality of positions on a side of the cell body 10, and at the same time, arranging the plurality of negative tabs 22 at the plurality of positions is able to effectively improve the cycle life of the cell.

Although the terms such as the cell body, the tab, the positive tab, and the negative tab are adopted more often here, the possibility of adopting other terms is not excluded. These terms are used only to describe and explain the essence of the disclosure more conveniently; and to interpret the terms as any kind of additional limitation would be contrary to the spirit of the disclosure.

According to the cell provided in the embodiments of the disclosure, by reasonably designing the relationship between the length L and the thickness H of the cell body, that is, the ratio between the length L and the thickness H of the cell body is defined within the specific relational expression of L/H>7, the heat dissipation performance of the cell is improved, and the heat inside the cell is discharged to the outside timely, such that the service life and safety performance of a battery are improved, thereby having a higher potential for market promotion.

### Embodiment 2

An embodiment of the disclosure provides a secondary battery, which includes a cell and a housing accommodating the cell. The cell is the cell as described in Embodiment 1.

It is to be noted that, the secondary battery shall further include necessary components such as a top cover, electrolyte and a current collector plate. The specific effect of the components is to guarantee normal operation of the functions of the secondary battery. In view of the fact that most of the components have been implemented in the related art, the components are not the focus of the design of the solution, such that deep elaboration is not made here.

In addition, the secondary battery in the embodiment may, but not limited to, be applied to electronic devices such as an electronic apparatus, an electric vehicle, or a power storage system. The electronic apparatus may be, for example, various devices such as computers, mobile phones and display screens that use the secondary battery as a driving power supply. The electric vehicle may be, for example, an electric automobile, an electric tricycle, an electric bicycle, or the like that uses the secondary battery as the driving power supply. The power storage system may be, for example, a power storage system that uses the secondary battery as a power storage source.

In these electronic devices, the secondary battery may be electrically connected to an electrical element, so as to provide electric energy to the electrical element. Since the quick charging capability of the secondary battery provided in the embodiment is excellent, the electronic devices are conductive to be used in application scenarios such as outdoor energy storage, short-time power reservation, and mobile energy storage, such that the electronic devices have wider application scenarios.

According to the secondary battery provided in the embodiments of the disclosure, by reasonably designing the relationship between the length L and the thickness H of the cell body, that is, the ratio between the length L and the thickness H of the cell body is defined within the specific relational expression of L/H>7, the heat dissipation performance of the cell is improved, and the heat inside the cell is discharged to the outside timely, such that the service life and safety performance of a battery are improved, thereby having a higher potential for market promotion.

To sum up, after reading the present detailed disclosure, it may be understood by those skilled in the art that the foregoing detailed disclosure may be presented by means of examples only, and may not be limiting. Although not expressly stated herein, it may be understood by those skilled in the art that the disclosure is intended to encompass a variety of reasonable changes, improvements and modifications to the embodiments. These changes, improvements and modifications are intended to be made by the disclosure and are within the spirit and scope of the embodiments of the disclosure.

In addition, certain terms in the disclosure have been used to describe the embodiments of the disclosure. For example, “an embodiment”, “Embodiment”, and/or “some embodiments” here mean that particular features, structures or characteristics described in combination with the embodiments may be included in at least one embodiment of the disclosure. Therefore, it is emphasized and should be understood that two or more references to “Embodiment” or “an embodiment” or “alternative embodiments” in various parts of this specification do not necessarily refer to the same embodiment. In addition, particular features, structures or characteristics may be suitably combined in one or more embodiments of the disclosure.

It should be understood that, in the foregoing description of the embodiments of the disclosure, various features are combined in a single embodiment, accompanying drawings, or description thereof for the purpose of simplifying the disclosure in order to aid in the understanding of a feature. However, this is not to say that the combination of these features is necessary, and it is entirely possible for a person skilled in the art to read the disclosure and extract some of these features as separate embodiments to be understood. That is to say, the embodiments in the disclosure may also be understood as an integration of a plurality of sub-embodiments. The content of each sub-embodiment is also valid when the content is less than all the features of a single previously disclosed embodiment.

Finally, it is to be understood that the technical solutions of the disclosure disclosed herein are descriptions of the principles of the embodiments of the disclosure. Other modified embodiments are also within the scope of the disclosure. Therefore, the embodiments disclosed in the disclosure are intended only as examples and not as limitations. A person skilled in the art may adopt alternative configurations to implement the disclosure according to the embodiments in the disclosure. Therefore, the embodiments of the disclosure are not limited to the embodiments precisely described in the disclosure.

What is claimed is:

1. A cell, comprising a cell body, and a length of the cell body is L, and a thickness of the cell body is H; and
the length L and the thickness H satisfy the following relational expression: L/H>7.

2. The cell according to claim 1, wherein further comprising a tab,
the tab is connected to the cell body and is led out from the cell body;
a width of the tab is M; and
the length L and the width M satisfy the following relational expression: L>5M.

3. The cell according to claim 2, wherein there are a plurality of tabs, and the plurality of tabs comprise a positive tab and a negative tab; and
the positive tab and the negative tab are arranged at intervals along a length direction of the cell body.

4. The cell according to claim 2, wherein there are a plurality of tabs, and the plurality of tabs comprise a plurality of positive tabs and a plurality of negative tab;
the plurality of positive tabs and the plurality of negative tabs are arranged at intervals along a length direction of the cell body,

5. The cell according to claim 4, wherein the plurality of positive tabs are arranged at intervals along the length direction of the cell body.

6. The cell according to claim 4, wherein the plurality of negative tabs are arranged at intervals along the length direction of the cell body.

7. A secondary battery, comprising the cell according to claim 1 and a housing accommodating the cell.

8. The secondary battery according to claim 7, wherein further comprising a tab,
the tab is connected to the cell body and is led out from the cell body;
a width of the tab is M; and
the L and the M satisfy the following relational expression: L>5M.

9. The secondary battery according to claim 8, wherein there are a plurality of tabs, and the plurality of tabs comprises a positive tab and a negative tab; and
the positive tab and the negative tab are arranged at intervals along a length direction of the cell body.

10. The secondary battery according to claim 8, wherein there are a plurality of tabs, and the plurality of tabs comprises a plurality of positive tabs and a plurality of negative tab;
The plurality of positive tabs and the plurality of negative tabs are arranged at intervals in a length direction of the cell body.

11. The secondary battery according to claim 10, wherein the plurality of positive tabs are arranged at intervals along the length direction of the cell body.

12. The secondary battery according to claim 10, wherein the plurality of negative tabs are arranged at intervals along the length direction of the cell body.
